(19) United States
(12) Patent Application Publication
(10) Pub. No.: US 2026/0261276 A1
(43) Pub. Date: Sep. 3, 2026

(54) DATA COMMUNICATIONS CASE

(71) Applicant: Plum Laboratories, Inc., Springfield, TN (US)

(72) Inventor: Asha Moran, Asheville, NC (US)

(21) Appl. No.: 19/554,224

(22) Filed: Mar. 2, 2026

Related U.S. Application Data
(60) Provisional application No. 63/765,381, filed on Feb. 28, 2025.

(51) Int. Cl. H04B 1/034

(52) U.S. Cl. CPC H04B 1/034

(57) ABSTRACT

A portable data communications apparatus and power platform are disclosed. A portable carrying case may house a router device configured to provide wide area network connectivity through at least one cellular gateway and local wireless network connectivity. An antenna system including at least one cellular antenna and/or a satellite communication antenna is operatively connected to the router device. A power system positioned within the case includes a power bank having a plurality of batteries electrically coupled in parallel and an electrical board including a power boost circuit configured to increase output wattage supplied to the satellite communication antenna, thereby enabling operation without a separate satellite-side router or power supply. The power platform may further provide power to external electronic devices through an output interface and may support transmission of both power and data through a single cable.

### CROSS-REFERENCES TO RELATED APPLICATIONS

This application claims priority to U.S. Provisional Patent Application No. 63/765,381 filed Feb. 28, 2025, and titled “Data Communications Case,” and which is currently pending.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

This present disclosure generally relates to the field of data communications.

More specifically, the present disclosure relates to facilitating various types of communications, including secure, high-speed data communications, and voice communications when current end user devices may detect that little or no wired, wireless, cellular, or other internet signal is available. Network failures and slow data communications occur for a myriad of reasons-from crowded networks to natural disasters-leading to frustrations in a society that is growing ever dependent on the ability to transmit and receive communications, including secure, high-speed data. Further, obtaining data and voice communication in remote areas without readily available power supplies, internet connectivity, and/or where cellular coverage is weak or non-existent can be difficult if not impossible, which can be especially undesirable for public safety officials and others that often rely on data and voice communications for work projects in rural environments and in disaster relief situations.

Conventional data communication units are large, bulky, and difficult to transport, and thus are typically retained in a generally fixed or permanent location. Additionally, conventional, portable antennas are typically located on the outside of a data communications unit, creating a cumbersome device that is not aesthetically pleasing, where the antennas are freely exposed to external wear, tear and breakage.

What is needed then are improvements to data communication units.

### BRIEF SUMMARY

In some respects, the disclosure is directed to a data communications apparatus for providing a data communications network, the apparatus having a portable carrying case; a router device positioned within the case, the router device including at least one cellular gateway configured for wide area network communication and at least one wireless network configured for local area network communication; an antenna system operatively connected to the router device, the antenna system including at least one cellular antenna and a satellite communication antenna; and a power system positioned within the case, the power system having a power bank configured to receive a plurality of batteries wired in parallel; and an electrical board including a power boost circuit configured to provide increased output wattage to the satellite communication antenna, wherein the electrical board is configured to power the satellite communication antenna without requiring a separate satellite-side router or power supply. The power system may further have a single cable extending between the power bank and the satellite communication antenna and configured to transmit both power and data. The plurality of batteries may be individually removable from the power bank. The plurality of batteries comprises four batteries, each battery configured to deliver at least 99 Wh of power when fully charged.

In some embodiments the apparatus may further have a base plate insertable within the case, and a bracket attached to the base plate, wherein the power bank is securable within the bracket. The electrical board is coupled to the base plate on an opposite side relative to the power bank.

In some embodiments the batteries may further provide power to each of the at least one cellular antenna and the satellite communication antenna. The apparatus of claim 1, wherein the power system includes a plurality of charging ports configured to receive power from at least one of an AC charger, vehicle charger, or solar panel.

In other respects, the disclosure is directed to a data communications apparatus having a portable carrying case, a router device positioned within the case, a satellite communication terminal stored within or mounted to the case and operatively connected to the router device, and a power system including a plurality of batteries electrically coupled in parallel and configured to provide power to the router device and the satellite communication terminal. The power system may further have an electrical board including a power boost circuit configured to increase output wattage supplied to the satellite communication terminal.

In some respects, the power system may include a microcontroller configured to monitor at least one of current draw, voltage, or power consumption of the satellite communication terminal. The microcontroller may be configured to automatically disconnect power to the satellite communication terminal when a power threshold is exceeded.

In some respects, the power system further includes a temperature sensor configured to cause power to be disabled when a temperature threshold is exceeded.

In some respects, the plurality of batteries are individually removable from a power bank positioned within the case.

In other respects, the disclosure is directed to a portable power platform having a carrying case, a power bank positioned within the case and configured to receive a plurality of batteries such that the plurality of batteries are coupled in parallel, an electrical board including a DC-to-DC power boost circuit, and an output interface configured to provide power from the power bank to at least one external electronic device selected from the group consisting of a satellite antenna, wireless access point, camera, or networking device. The electrical board may include a power-over-Ethernet (PoE) power injector circuit. The output interface may be configured to provide power through a single cable configured to transmit both power and data to a satellite antenna. The power bank may include four removable lithium-ion batteries each having a capacity of at least about 99 Wh. The electrical board may include a DC-to-DC boost circuit configured to power an external device without converting power from direct current to alternating current. The carrying case may include a plurality of charging ports configured to receive power from at least one of an AC charger, vehicle charger, or solar panel.

### BRIEF DESCRIPTION OF THE DRAWINGS

FIG. 1 is a perspective view of an embodiment of a data communications apparatus of the present disclosure with a lid of the apparatus in an open position to provide access to internal components of the apparatus.

FIG. 2 is a perspective view of the data communications apparatus of FIG. 1 with the lid in the closed position.

FIG. 3 is a cross section view of the apparatus of FIG. 1 with the lid of the apparatus in an open position.

FIG. 4 is a view of a power bank for use with the apparatus of FIG. 1.

FIG. 5 is another view of a power bank for use with the apparatus of FIG. 1.

FIG. 6 is another view of a power bank and base plate for use with the apparatus of FIG. 1.

FIG. 7 is a depiction of a battery power meter for use with the apparatus of FIG. 1.

FIG. 8 depicts the power bank and base plate within a case of the apparatus of FIG. 1.

FIG. 9 is a cross section view of the apparatus of FIG. 6 with the lid of the apparatus in a closed position.

FIG. 10 depicts a GPS antenna for use with the apparatus of FIG. 1.

FIG. 11 is a cross section view of the base of FIG. 1 showing one or more fastening straps adhered to an inner side of the case and secured around corresponding internal components of the apparatus.

FIG. 12 is a front view of the apparatus of FIG. 1.

FIG. 13 is a perspective view of another embodiment of a data communications apparatus of the present disclosure having an antenna array with multiple pairs of cellular antennas.

FIG. 14 is a front perspective view of the apparatus of FIG. 13.

FIG. 15 is a perspective view of another embodiment of a data communications apparatus of the present disclosure having an antenna array with multiple antennas contained within an antenna housing.

FIG. 16 is a perspective view of another embodiment of a data communications apparatus of the present disclosure.

FIG. 17 is a top perspective view of another embodiment of a data communications case including a satellite phone.

FIG. 18 is a top perspective view of the embodiment of FIG. 17.

FIG. 19 is a rear detailed view of a plurality of rear external ports on a data communications case of the present disclosure

FIG. 20 is a front perspective view of another embodiment of a data communications case including a satellite antenna.

FIG. 21 is a side perspective view of another embodiment of a data communications case including a satellite antenna pivotally mounted to a case.

FIG. 22 is a front perspective view of another embodiment of a data communications case including an IMARSAT type satellite antenna pivotally mounted to a case.

FIGS. 23-25 show various views of the data communications case of FIG. 22 with the satellite antenna in an extended position.

FIG. 26 depicts a motherboard for controlling the power bank depicted in FIG. 4.

FIG. 27 depicts an embodiment of a satellite plate stored within a removable tray for use with the various embodiments.

FIG. 28 depicts a removable tray and satellite plate.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. Positional terms used herein such as “upper,” “lower,” “side,” “top,” “bottom,” etc. refer to the apparatus when in the orientation shown in the drawing that is being referred to in the accompanying description. A person of skill in the art will recognize that the apparatus can assume different orientations when in use.

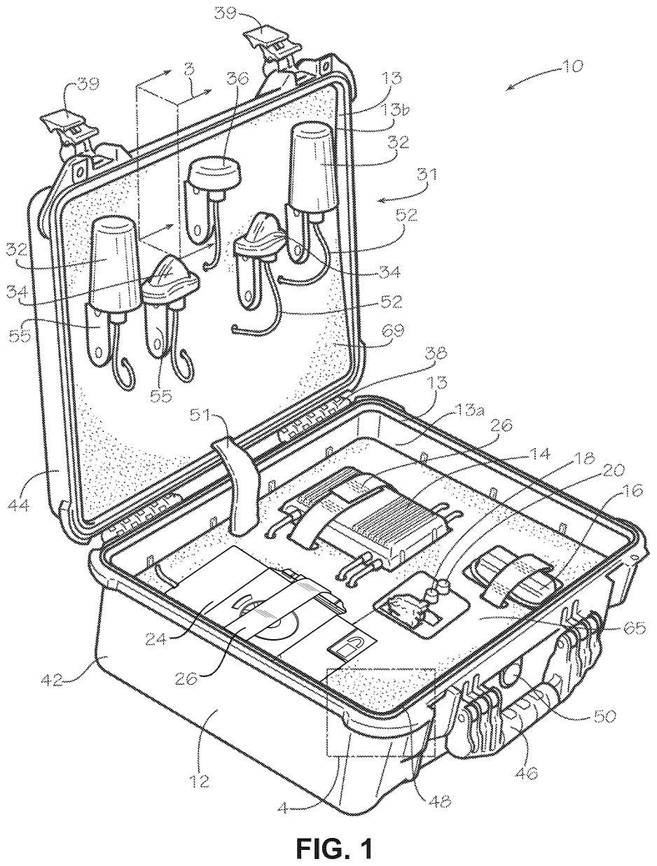

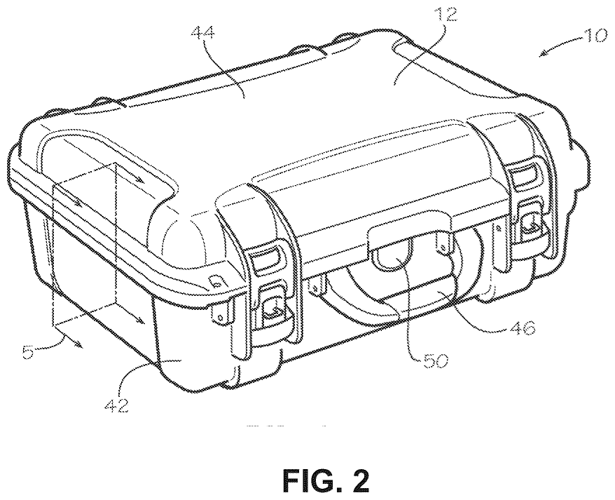

An embodiment of the data communications apparatus 10 containing various components is shown in FIG. 1. Apparatus 10 can include a case 12. In some embodiments, the case 12 can include a base 42 and a lid 44 connectable to base 42. Lid 44 can be movable with respect to base 42 between an open position and a closed position. In FIG. 1, lid 44 is shown pivotally connected to base 42 via hinge 38, such that lid 44 can rotate with respect to base 42 between an open and a closed position. One or more latches or clasps 39 can secure lid 44 to base 42 when lid 44 is in the closed position, as shown in FIG. 2. In other embodiments, lid 44 can be detachable from base 42 such that lid 44 can be connectable on base 42 and secured thereto via two or more latches or clasps 39 positioned around the periphery of case 12. Moving lid 44 from a closed position, as shown in FIG. 2, to an open position, as shown in FIG. 1, can provide a user access to the internal components of case 12. Case 12 can include a handle 46 which can be grasped by a user to facilitate carrying apparatus 10 and case 12.

The sidewalls of case 12 can be made from any suitable material, including but not limited to polypropylene, which can help provide impact resistance, waterproofing, crush-proofing, and dustproofing characteristics to case 12. The sidewalls of case 12 may also comprise various other polymers including polyethylene, high-density polyethylene, polyurethane, polyester, nylon, silicone rubber, polycarbonates, and various other polymers known in the art. As shown in FIG. 6, case 12 can include an inner surface 13, which can include base inner surface 13a and lid inner surface 13b. Base inner surface 13a can define a base cavity 15a, and lid inner surface 13b can define a lid cavity 15b. Components contained within case 12 can be positioned in either base cavity 15a or lid cavity 15b. In some embodiments, one or more components of the case can be connected outside or to an exterior of the case 12.

In certain embodiments, case 12 meets or exceeds U.S. military specifications for ruggedized equipment. The interior dimensions of case 12 are approximately 18.0-20.0 inches in length by 12.0-14.0 inches in width by 6.0 to 8.0 inches in height; and the exterior dimensions of case 12 are approximately 19.0-21.0 inches in length by 15.0-17.0 inches in width by 7.0-9.0 inches in height. For the embodiment shown in FIG. 1, the weight of case 12 when empty is approximately six to eight pounds. The size and weight of case 12 can be varied in different applications to increase or decrease the size and weight of case 12 and apparatus 10 as desired for different uses and to accommodate varying numbers of internal components as necessary. In some embodiments, exterior length of the case can be between 12 and 40 inches, the width can be between about 8 and about 21 inches, and the depth can be between about 5 and 13 inches. A case 12 designed to be easily portable and easy to transport can be beneficial in various situations and applications, for instance when used by emergency responders and other public safety officials who can conveniently transport apparatus 10 to disaster relief areas or other remote areas without power, wireless service, and/or voice service. The size and weight of case 12 and apparatus 10 can also be varied for business and salespersons that may travel frequently and desire to have ready access to data and voice communications capabilities.

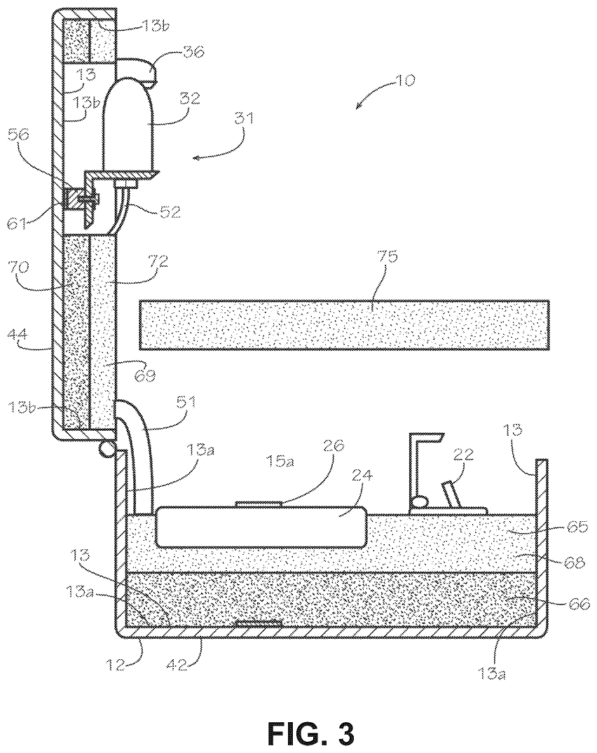

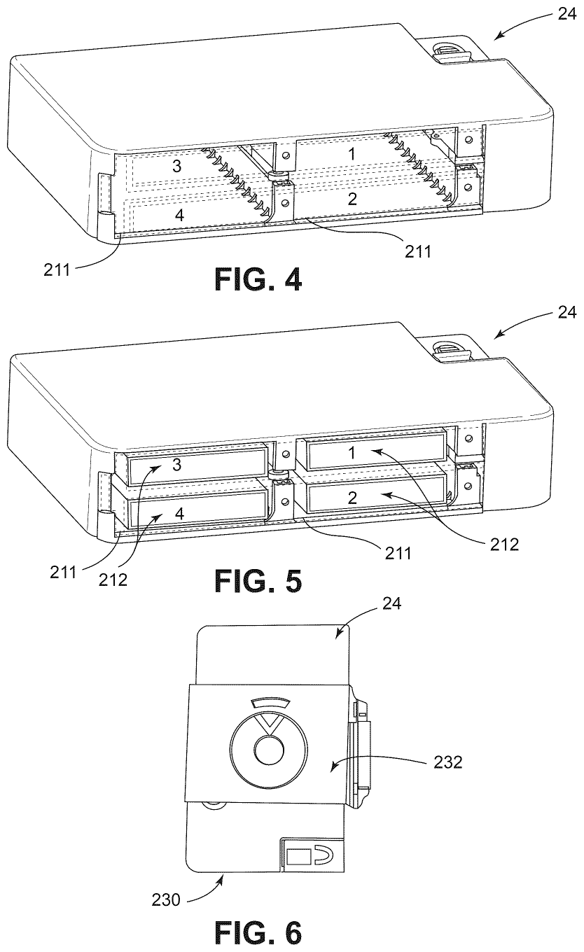

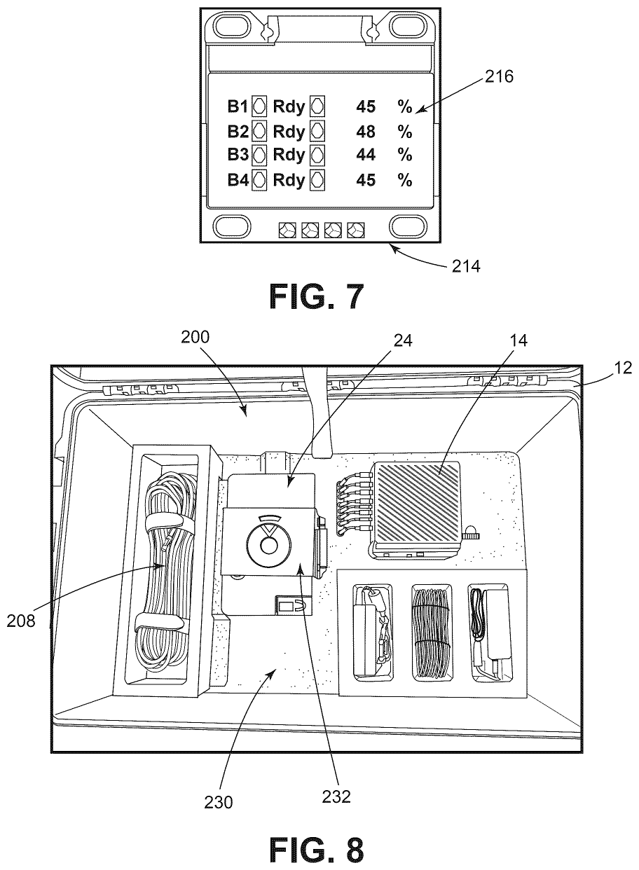

Referring again to FIGS. 1 and 3, apparatus 10 can include a router device 14 secured within case 12, and a power system 200 secured within case 12. The power system 200 is capable of providing power for a combination of cellular antennas 32, wireless antennas 34, and/or satellite antennas 118. The power system 200 may also be referred to herein as a portable power platform 200. Any portion of this disclosure may be applicable to the embodiment shown and discussed in relation to FIGS. 4-8 and 26-28. Such a power system 200 may provide power to the cellular system alone for up to 56 hours, or the cellular and satellite system combined for up to 10 hours, without changing or recharging the power supply. The power system 200 includes a power bank 24 capable of receiving a plurality of batteries 212. In some embodiments, the power bank 24 may have four bays, each bay capable of receiving and connecting to a battery 212. In some embodiments a battery 212 may be a 99.6 Wh lithium-ion UL/UM battery. A configuration of four 99.6 Wh lithium-ion batteries 212 provides 398.84 Wh of power. Advantageously, such batteries 212 allow the apparatus to be ground shipped without hazardous goods certifications and to be checked as baggage under current Federal Aviation Administration (FAA) regulations. The power bank 24 is configured to wire the batteries 212 in parallel. An example power bank 24 is shown in FIG. 4. An example of the power bank as installed in a case 12 is shown in FIG. 8. In some embodiments, the power system 200 defines an integrated portable power architecture configured to supply power to the router device 14 and at least one satellite antenna 118 from the plurality of batteries 212 without requiring external power equipment. The system permits one or more batteries to be removed and replaced for recharging while other batteries continue to provide uninterrupted power.

A power bank 24 such as described above is lightweight yet provides significant power. It is also capable of being stored in a portable case 12 such as described elsewhere in this disclosure. FIG. 6 depicts a base plate 230 for securing various components within the case 12. A bracket 232 is attached to the base plate 230. The bracket 232 securely holds the power bank 24 to prevent the power bank 24 from moving around while the case 12 is being carried or transported. The base plate 230 may include other elements, such as the router 14 and power cables 208 coupled thereto. In some embodiments the base plate 230 may be removable from the case 12. In other instances the base plate 230 may be secured within the base 42 of the case 12. The base plate 230 may also include an electrical board 220 for implementing the electrical wiring of the of the power bank 24. FIG. 8 shows an embodiment of an underside of the base plate 230 depicted in FIG. 6 and shows an embodiment of such an electrical board 220. The electrical board 220 may include a 48 V booster and power-over-ethernet (PoE) power injector including a boost circuit to increase the maximum wattage. For example, the wattage may be increased to 120 W, the amount of power amount necessary to operate Mini, Standard or Performance STARLINK® satellite antennas. Other increased power amounts may be desirable based on the amount of power required by the satellite system operated in connection with the case 12. Where the satellite antenna 118 operates on DC power, the power bank 24 to satellite power boost may use a DC-to-DC power or PoE boost. This avoids the need for a DC to AC transform and a subsequent AC to DC transform and is approximately 20% more efficient.

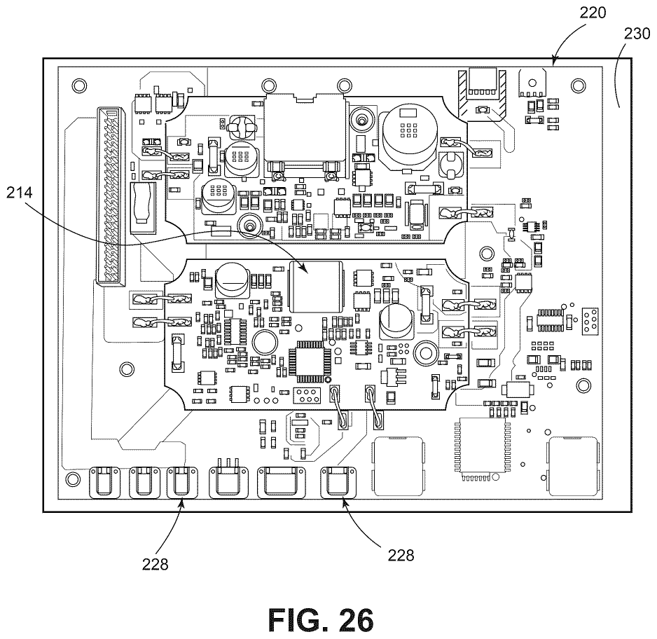

In some embodiments as depicted in FIG. 26, the electrical board 220 may also include a microcontroller 214 taking measurements of the current, voltage, and power drawn by the satellite antenna 118. If the satellite antenna 118 begins to draw more power than a preset limit, the microcontroller 214 may automatically cut power to the satellite antenna 118. In an embodiment using a STARLINK® satellite, the preset power limit may be 120 W. The microcontroller 214 may further control operation of the boost circuit to regulate power delivery to the satellite antenna 118. Power bank 24 may have additional output ports for charging laptops, notebooks, notepads, cellular phones, etc. In certain embodiments, various adapters that allow for power to be supplied to other external components may also be housed within case 12 and connected to power bank 24.

In some embodiments the electrical board 220 may further include a temperature senser connected to the microcontroller 214 or to a charger. If the temperature exceeds a preset limit, the microcontroller 214 can turn off all power to the case 12 to prevent overheating.

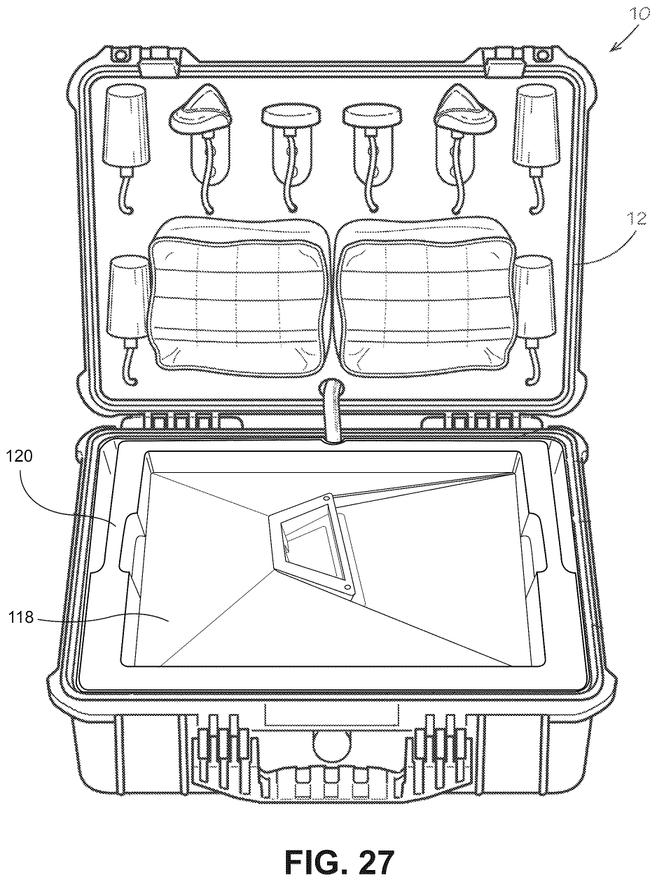

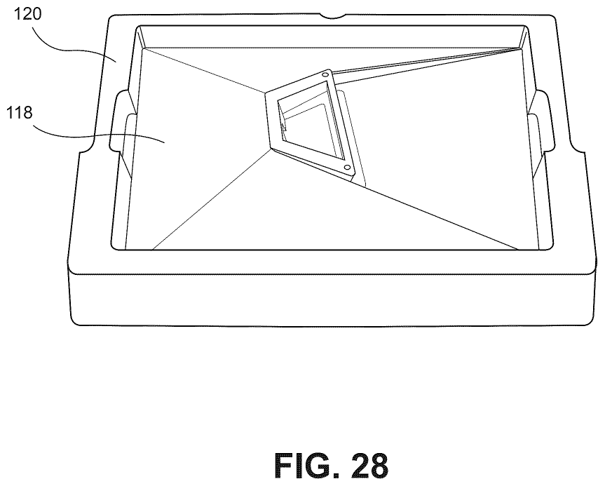

The satellite may may be a flat satellite dish such as a STARLINK® satellite dish. Such an embodiment is depicted in FIGS. 27-28 with the satellite 118 stored within a removable tray 120. The removable tray may hold and store the satellite 118 within the case 12 when the apparatus is being stored or transported. The removable tray 120 and satellite 118 may be removed from the case and the satellite 118 connected to the apparatus 10 for use when ready to be deployed.

The router device 14 can selectively receive power from the power bank 24 within the power system 200. Apparatus 10 can include an AC/DC adapter 16. The power bank 24 can be connected to adapter 16 and adapter 16 can be plugged into an external power grid in order to recharge batteries within the power bank 24 between uses of apparatus 10, or while apparatus 10 is being used and power bank 24 is depleted. In some embodiments, apparatus 10 can include a second external power source which can be a second standalone power source such as a solar cell, battery, or load cell which can be connected to power source 24. A second standalone power source can help prolong the usable life of apparatus 10 when apparatus 10 is used in remote area or areas without access to a utility power grid. In some embodiments, the second standalone power source can be configured to provide multiple days of additional power to apparatus 10. Alternatively, in some embodiments, the external power source may be used to recharge batteries in the power bank 210. In some embodiments, the second external power source can be contained in its own, waterproof protective case such that the second standalone power source is protected as described herein. Case 12 and the case for the second standalone power source can be positioned side by side or on top of one another and the secondary power source can be connected to power source 24.

A power switch 22, a main fuse 18, and an auxiliary fuse 20 can also be secured within case 12. Power switch 22 can be in electrical communication with power bank 24 and router device 14 and can be selectively toggled by a user to turn on apparatus 10 and supply power from power supply 24 to router device 14. Main fuse 18 and auxiliary fuse 20 can be utilized to power additional electrical devices if desired, for instance external lighting sources, which can be beneficial in times of power outages or in remote locations away from electrical power grids. Power supply 24, router device 14, power switch 22, main fuse 18 and auxiliary fuse 20 can be connected to one another by low voltage (approximately 9V to 36V) electrical wiring that is coated with a suitable insulating material (e.g., flame-retardant polyvinyl chloride), having an approximate thickness of 0.007-0.011 inches. An insulated coating on the electrical wiring can help reduce electromagnetic interference between the wiring, as well as with other electrical components of apparatus 10.

In certain embodiments, router device 14 comprises a built-in modem, a cellular gateway, WAN/LAN switchable ports, and a wireless network adapter. In certain embodiments, router device 14 is capable of utilizing a firewall to block unauthorized access to communications sent and/or received via router device 14. In certain embodiments, router device 14 is capable of enabling multiple, segmented wireless networks, which can either be public or private wireless networks. The multiple wireless networks may have separate and different service set identifiers (SSIDs), each of which may be defined with passcodes. It is advantageous that router device 14 be capable of encrypting data communications via various encryption protocols (e.g., encrypting WiFi communications with WEP, WPA, WPA2, etc.). It may also be advantageous that router device 14 be programmable to allow for load balancing.

Further, each wireless network may be capable of having multiple users. In some embodiments, each wireless network and SSID can simultaneously accommodate multiple users. In some embodiments, router device 14 can enable multiple separate wireless networks and SSIDs, such that apparatus 10 can accommodate additional users on the separate wireless networks. Router device 14 may utilize either static or dynamic IP addressing schemas. In certain embodiments, router device 14 may enable 802.11 wireless connectivity utilizing distinct wireless frequencies (e.g., 2.4 GHz, 3.6 GHz, 4.9 GHz, 5 GHz, or 5.9 GHz). in certain embodiments, router device 14 may enable 802.11 wireless connectivity in a, b, g, k, n, v and/or ac standard configurations. In certain embodiments, router device 14 may be programmed via a cloud based device manager. In certain embodiments, router device 14 can include multiple cellular gateways such that router device 14 may accommodate and communicate with more than one cellular carrier.

In certain embodiments, router device 14 may have multiple WAN/LAN/RJ-45ports for failover if a user wishes to directly connect to router device or utilize satellite signal as WAN 14. In certain embodiments, router device 14 may comprise a Gobi® radio.

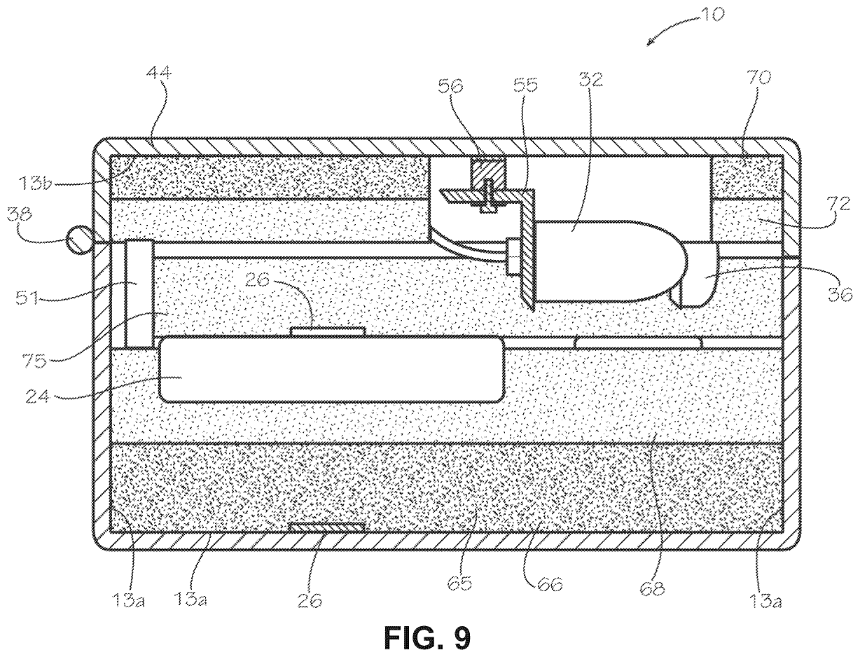

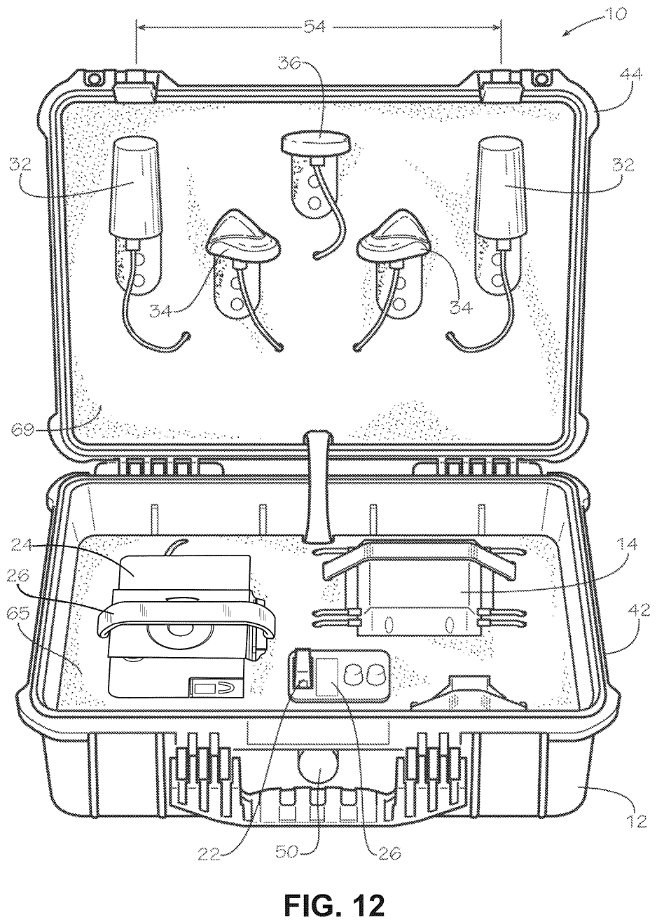

An antenna array 31 can be in electrical communication with router device 14. Antenna array 31 can include one or more cellular antennas 32, one or more wireless network (e.g. Wi-Fi®) antennas 34, and at least one global positioning system (GPS) antenna 36 secured to the case. In some embodiments, each of the antennas 32, 34, and 36 in the antenna array 31 can be retained within, or attached to an inside surface 13 of case 12. In certain embodiments, antennas 32, 34, and 36 of antenna array 31 may be attached to the lid inside surface 13b of lid 44, as shown in FIGS. 1 and 6. In other embodiments, as shown in FIG. 12, antenna array 31 can be secured in, retained within, or attached to base 42 of case 12. In some embodiments, each antenna 32, 34, and 36 of antenna array 31 can be separately mounted or attached within case 12, as shown in FIG. 1. In other embodiments, each of the antennas of antenna array 31 can be contained together in an antenna housing 64, and antenna housing 64 can be contained within or attached to either base 42 or lid 40 of case 12 at a single location, as shown in FIG. 12. The location of antenna array 31 inside case 12 is beneficial because conventional, portable antennas are typically located on the outside of a data communications unit, creating a cumbersome device that is unaesthetically pleasing where the antennas are freely exposed to external wear, tear and breakage. In contrast, antennas 32, 34, and 36, as well as the other electrical components of apparatus 10 can be protected by case 12 when lid 44 is in the closed position, which can help prevent damage to the integral electrical and/or communication components of apparatus 10. When lid 44 is in the closed position, case 12 can enclose and protect power bank 24, router device 14, and antenna array 31, as shown in FIGS. 2 and 9.

In the embodiment shown in FIG. 1, two cellular antennas 32 are utilized to cover frequencies across 700 and 800 MHz as well as all global cellular frequencies from 617-960 MHz and 1710-6000 MHz. Cellular antennas 32 of the embodiment in FIG. 1 may require a ground plane. For the embodiment shown in FIG. 1 and discussed above, it has been discovered that vertical polarity cellular antennas requiring a ground plane may be particularly advantageous. Ground plane independent cellular antennas and horizontal polarity cellular antennas, however, may also be used in other embodiments. Cellular antennas 32 of the embodiment in FIG. 1 may allow for multiple user and multiple-input and multiple-output (MiMo) applications. As shown in FIG. 12, cellular antennas 32 can be positioned at a cellular antenna separation distance 54 from one another within case 12 to help reduce frequency interference between cellular antennas 32. In one embodiment, cellular antenna separation distance 54 is at least 12 inches. In one embodiment, the separation distance can be at least 9 inches. In certain embodiments, the cellular antennas 32 can be configured to receive at least 2 watts of power from the power supply when the data communications case 10 is in use.

In some embodiments, the cellular antennas can be configured to receive between 2 and 5 watts of power from the power supply. Receiving such power from a power supply can help increase the gain of the cellular antennas and increase the transmission distance of the cellular antennas, which can be beneficial in emergency situations when local cells towers are down and the cellular antennas 32 are required to communicate with distant cell towers. In some embodiments, the cellular antennas 32 can have a transmission range of at least 30 miles. In some embodiments, the cellular antennas 32 can have a transmission range of at least 50 miles. In some embodiments, the cellular antennas 32 can have a decibel gain of between about 1 and 3 dB across the cellular frequencies noted previously.

In certain embodiments, GPS antenna 36, as shown in FIG. 1, can be included in the data communications case. A plurality of GPS antennas may be used. The GPS antenna(s) may be active or passive GPS antennas.

In certain embodiments, the wireless antennas 34, as shown in FIG. 1, have a frequency range of 2.4/5 GHz. In certain embodiments, the wireless antennas 34 enable multiple user and multiple-input and multiple-output applications. In certain embodiments, a user may be able to utilize a virtual private network (VPN) with any combination of the multiple wireless networks and/or any wired network port. In certain embodiments, more than two wireless antennas can be used to further increase the capacity of the wireless network and to further support MiMo applications.

Antenna cables 52 may connect various components inside the case 12 to the antennas 32, 34, 36. The antenna cables 52 may be channeled through a conduit 51, which allows for discrete and organized bundling of the antenna cables 52 and other cables connecting components within the case. Various components inside the case 12 may also be interconnected wirelessly. It is advantageous to utilize cables having as short as a length as possible to avoid attenuation. It is also advantageous to utilize low attenuation cables.

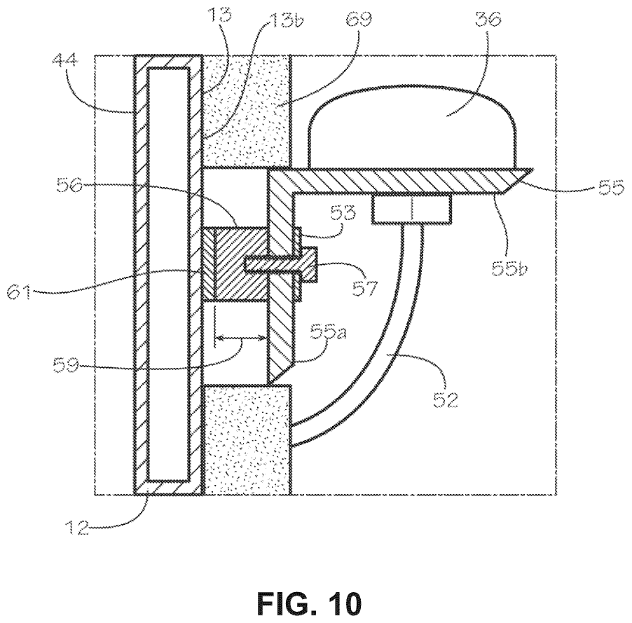

In certain embodiments, as shown in FIGS. 1, 3, and 10, antennas 32, 34, 36 are securely mounted within case 12 to lid inside surface 13b of lid 44. Apparatus 10 can include a plurality of mounting brackets 55 which can be adhered to lid inside surface 13b. Each antenna 32, 34, and 36 of antenna array 31 can be secured inside lid 44 to a corresponding mounting bracket 55. In some embodiments, each mounting bracket 55 can be substantially L-shaped. A first bracket portion 55a of bracket 55 can be positionable substantially parallel to lid inside surface 13b, first bracket portion 55a being adhered to lid inside surface 13b. A second bracket portion 55b can extend away from lid inside surface 13b when mounting bracket 55 is adhered to lid inside surface 13b. A corresponding antenna, shown as GPS antenna 36 (by way of example only) in FIG. 10, can be mounted to second bracket portion 55b. In one embodiment of the invention, second bracket portion 55b may be shaped and sized to serve as a ground plane for any one or more than one of the antennas of the antenna array.

In certain embodiments, as shown in FIG. 10, each mounting bracket 55 can include at least one resilient polymer stud 56 having a stud length 59. Polymer studs 56 can be adhered to an inner surface 13 of case 12, and in some embodiments to lid inner surface 13b, and to first bracket portion 55a of a corresponding mounting bracket 55 such that mounting brackets 55 are adhered to lid inner surface 13b via polymer studs 56. Particularly, one end of each stud 56 can be adhered to lid inner surface 13b, and an opposing end of each stud 56 can be attached or adhered to first portion 55a of a corresponding mounting bracket 55. In some embodiments, as shown in FIG. 10, each mounting bracket 55 can have an internal grommet or hole within the first portion 55a of mounting bracket 55 and each polymer stud 56 can have a threaded receptacle such that first portion 55a of mounting bracket 55 can be secured to polymer stud 56 by a screw, bolt, or other suitable fastener 57. In some embodiments, a washer 53 can be positioned between mounting bracket 55 and fastener 57 to help disperse the force of fastener 57 against mounting bracket 55.

In other embodiments, one end of each stud 56 can be adhered to lid inner surface 13b, and an opposing end of each stud 56 can be adhered to first portion 55a of a corresponding mounting bracket 55. In still other embodiments, each polymer stud 56 and corresponding mounting bracket 55 can be integrally formed together as one continuous or unitary piece.

In certain embodiments, studs 56 can have a circular longitudinal cross section including a diameter of at least 0.5 inches and a stud length of at least 0.5 inches. In some embodiments, studs 56 can have a diameter of about .825 inches and a length of about 1-2 inches, or longer. Studs 56 can therefore extend inward from lid inner surface 13 b a distance of at least 0.5 inches. Studs 56 can be comprised of a resilient polymer capable of dampening shock and vibration, such as polychloroprene. In certain embodiments, each stud 56 may be secured to lid inner surface 13b of lid 44 by a structural adhesive 61, such as a structural cyanoacrylate. One example of a suitable structural cyanoacrylate adhesive is BP Blue™, which can be purchased from Tech-Bond Solutions™ of Columbus, Ohio. In certain embodiments, the opposite ends of each stud 56 can also be secured to corresponding mounting brackets 55 via a similar structural adhesive, such as the structural cyanoacrylate discussed herein. While other mechanisms may be used to secure the antennas within case 12, structurally adhering studs 56 to corresponding inner surface 13 of case 12 via structural adhesives such as structural cyanoacrylates can allow antennas 32, 34, and 36 to be secured within case 12 without having to penetrate case 12.

Referring again to FIGS. 1 and 10, mounting brackets 55 used to secure antennas 32, 34, and 36 within case 12 should be configured to allow for secure placement of antennas 32, 34, and 36 on corresponding mounting brackets 55 via suitable antenna fasteners (e.g., screws, nuts, bolts) and to provide any necessary ground plane for antennas 32, 34, and 36. Mounting brackets 55 and the fasteners used to hold antennas 32, 34, and 36 in place on corresponding mounting brackets 55 within case 12 may include powder coated steel or stainless steel.

Mounting brackets 55 can be positioned at a predetermined distance away from the inside of case 12 via polymer studs 56, in some embodiments a distance of at least 0.5 inches, such that antennas are located at a sufficient distance from lid inner surface 13b of lid 44 so that case 12 may be comfortably closed, and so that antenna array 31 may have unimpeded, open-air exposure when lid 44 is in the open position. Affixing antennas 32, 34, and 36 to mounting brackets 55 on inner surface 13 of case 12 can allow for case 12 to be waterproof and dustproof and can help reduce the problem of antennas 32, 34, and 36 being easily dislocated or knocked off a data communications unit.

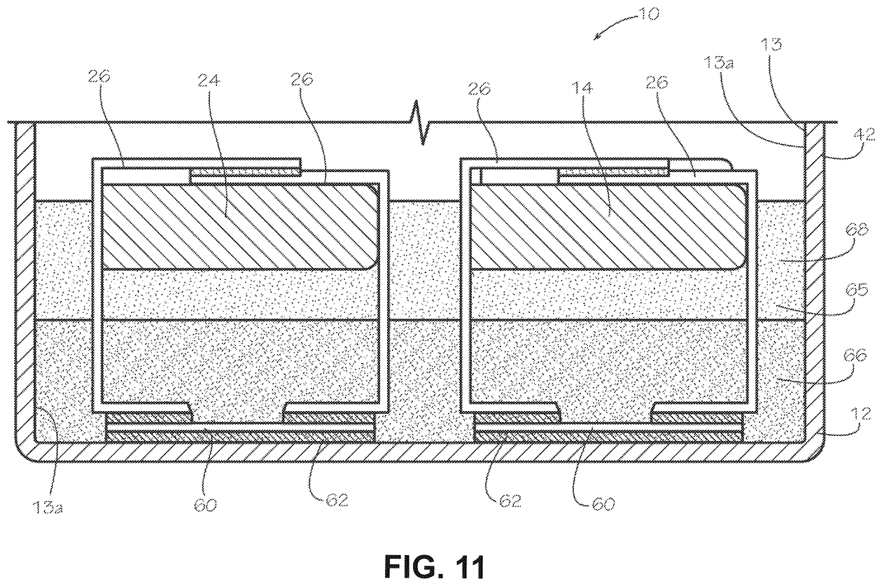

Other mechanisms for mounting, securing, or positioning the elements within the case may be used. For example, as shown in FIGS. 1 and 11, apparatus 10 can include a plurality of fastening straps 26 adhered to case 12. Each of power bank 24, router device 14, and power switch 22 can be secured within case 12 with at least one corresponding fastening strap 26. Fastening straps 26 may incorporate hook and loop fasteners, zippers, removable adhesives, buttons, snaps, clips, or any other suitable fastening members to secure fastening straps 26 together around corresponding components of apparatus 10 to secure the components within case 12. Fastening straps 26 in some embodiments can include audible snap closures. Fastening straps 26 can be adhered or structurally bonded to either base 42 or lid 44 as desired to secure the various components of apparatus 10 to either base 42 or lid 44.

In some embodiments, fastening straps 26 may be sewn, adhered, or otherwise attached to corresponding polymer strips 60. Polymer strips 60 can be adhered to inside surface 13 of case 12 by a polymer strip structural adhesive 62 such as a structural cyanoacrylate. As such, fastening straps 26 can be adhered to case 12 via polymer strips 60. A polymer strip structural adhesive 62 including a structural cyanoacrylate can form a covalent bond between polymer strips 60 and inside surface 13 of case 12 to help provide a strong and reliable attachment of polymer strips 60 to case 12. Adhering polymer strips 60 and fastening straps 26 to case 12 can help maintain the integrity of case 12 as polymer strips 60 and fastening straps 26 are not secured to case 12 by mechanical fasteners such as screws or bolts that can penetrate case 12.

In some embodiments, fastening straps 26 may be sewn to the polymer strips 60 using sewing thread that meets or exceeds U.S. military specifications. In other embodiments, fastening straps 26 can be adhered to polymer strips 60. In still other embodiments, the fastening straps 26 may be adhered directly to inner surface 13 of case 12.

Polymer strips 60 may comprise polychloroprene, nylon-reinforced polychloroprene, or another suitable polymer. Polymer strips 60 made of nylon-reinforced polychloroprene have been found to be particularly advantageous.

In some embodiments, as shown in FIG. 1, router device 14, power bank 24, and power switch 22 can be secured in base 42 via suitable fastening strips 26, and each antenna 32, 34, and 36 of antenna array 31 can be secured within lid 44 via a corresponding mounting bracket 55. In other embodiments, as shown in FIG. 12, one or more of power bank 24 and/or router device 14 can be secured in lid 44 via fastening strips 26, and antenna array 31, positioned within antenna housing 64, can be secured within base 42 by fastening straps 26.

Referring again to FIG. 1, and also shown in FIG. 3, the communications components positioned within case 12 can be further secured and protected within case 12 by cushions, such as a base foam cushion 65 or lid foam cushion 69, or by acrylonitrile butadiene styrene (ABS) plates within the base.

In some embodiments, base 42 can include a rigid insert which can house one or more components of the apparatus 10, including but not limited to the power supply 24, the router device 14, or the antenna array 31. In some embodiments, the rigid insert can include a plurality of recesses for receiving various components of the apparatus 10. The rigid insert can be made from a metal, plastic, or other suitable rigid material and can provide structural support and protection for the components of the apparatus 10 positioned within case 12.

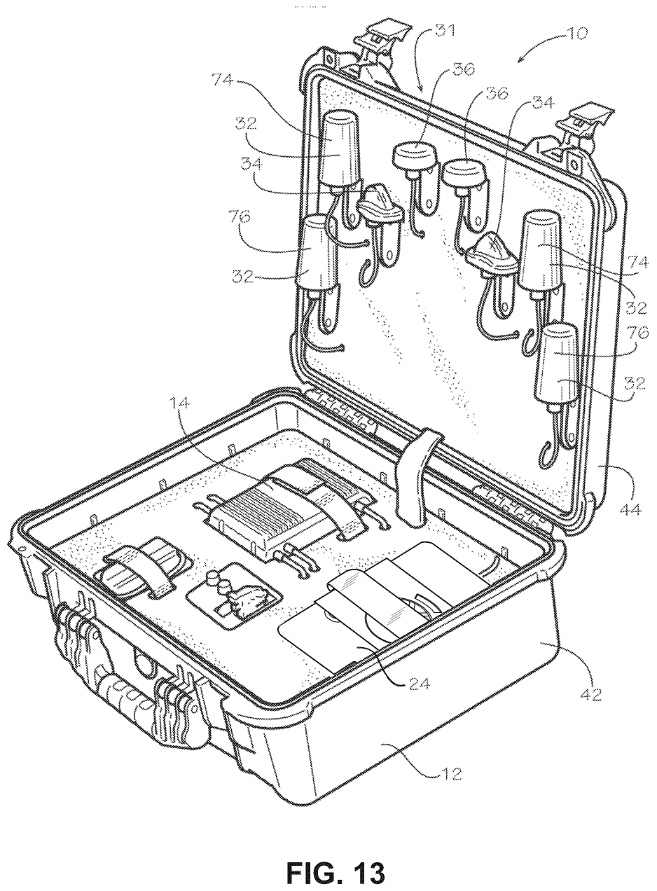

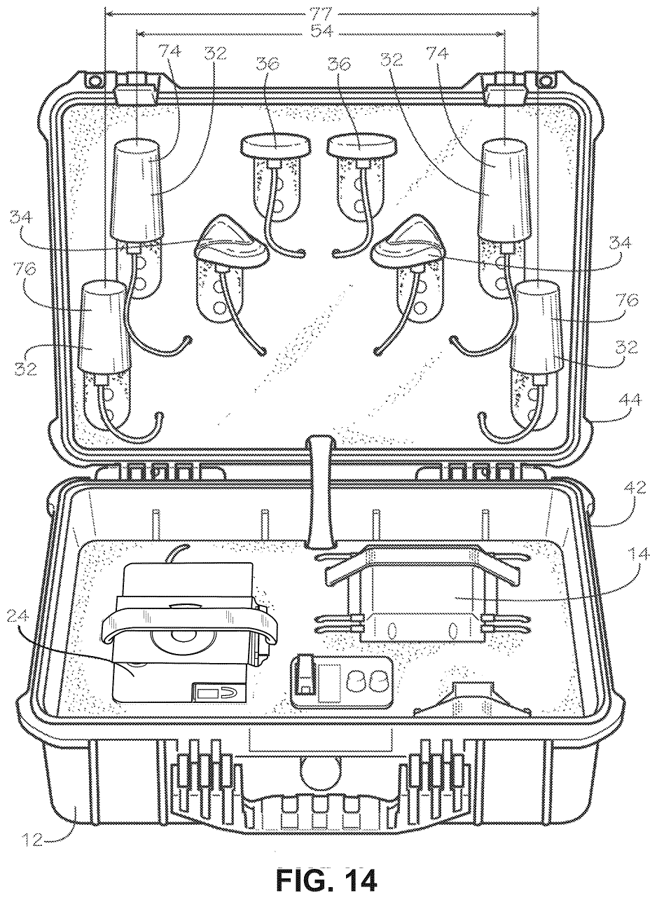

Another embodiment of a data communications case 12, shown in FIGS. 13-14, includes an antenna array 31 having a first pair 74 of cellular antennas 32, and a second pair 76 of cellular antennas 32. In some embodiments, first pair 74 of cellular antennas 32 can be positioned at least 12 inches apart from one another within case 12, and second pair 76 of cellular antennas 32 can be positioned at least 12 inches apart from one another within case 12, which can help reduce frequency interference between cellular antennas 32. In other words, cellular antenna separation distance 54 between first pair 74 of cellular antennas 32 can be greater than or equal to about 12 inches, and second cellular antenna separation distance 77 can be greater than or equal to about 12 inches. Each pair 74 and 76 of cellular antennas 32 can be capable of sending and receiving a signal across a cellular network, such that apparatus 10 of FIGS. 13-14 when used can accommodate cellular service with two different cellular carriers.

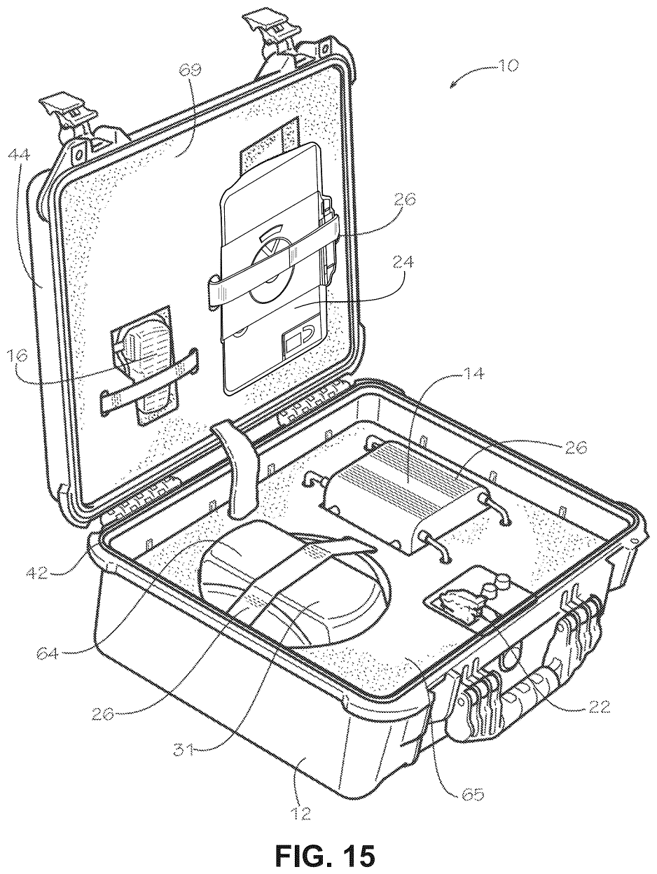

In one embodiment shown in FIG. 15, antenna array 31 is contained in an antenna array housing 64 retained or secured to base 42 using one or more fastening straps 26. Antenna array 31 and antenna array housing 64 can also be described as being a singular antenna with multiple antenna elements. In one embodiment, the antenna housing 64 can contain five isolated high performance antenna elements, including two cellular antenna elements utilizing distinct wireless frequencies and supporting MiMo; two dual band wireless antenna elements supporting MiMo and diversity operation for WIFI and WiMax wireless networks; and one GPS antenna element. In some embodiments, the antenna elements in antenna array housing 64 can be ground plane independent such that antenna array 31 can be positioned either in lid 44 or in base 42 of case 12, and the antenna elements can maintain a generally high performance even when mounted on a non-metallic surface.

Having antenna array 31 compactly arranged within a durable case 12, and particularly within a compact antenna housing 64, as shown in FIG. 12, can help reduce the space necessary to accommodate antenna array 31 within case 12. As such, the overall size, weight, and profile of case 12 can be reduced if desired. In some embodiments, the overall size of case 12 in FIG. 15 can be about 15 inches in length by 11 inches in width. Having a smaller overall size of case 12 can further help make case 12 more convenient to transport. For instance, for a smaller office setting where less communication capabilities are needed, case 12 of FIG. 15 can easily be transported between various locations on site as desired. Additionally, hospitals having nurses moving from room to room and documenting patient status can carry a smaller case 12 with them such that they have wireless access with them at all times and can update patient records on a hospital network or system in real time as they move from patient to patient. Similarly, traveling sales forces can conveniently carry a smaller case 12 with them to remote business meetings to ensure they have wireless and cellular service. Other uses and applications of the relatively smaller case of FIG. 15 will be readily apparent to one of skill in the art.

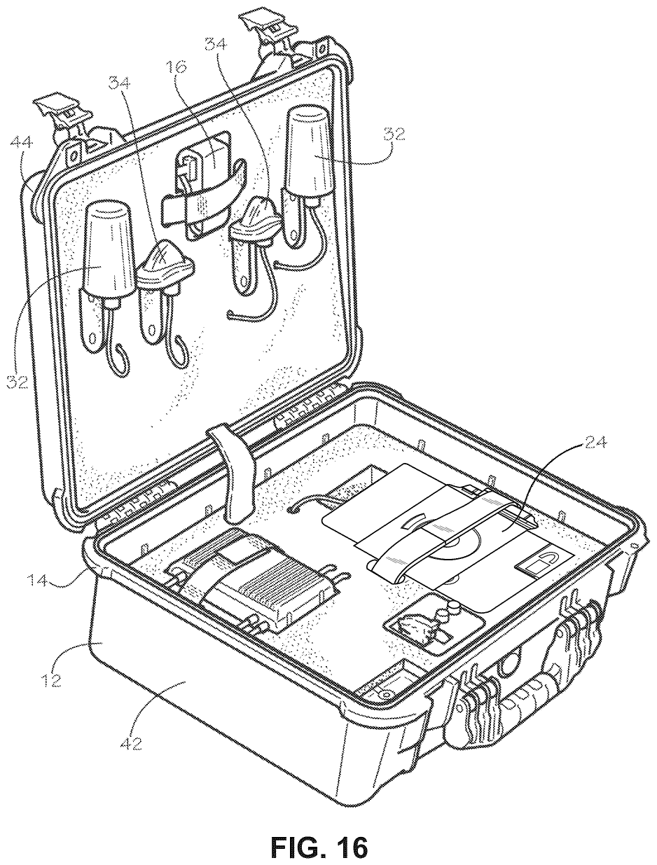

In another embodiment, shown in FIG. 16, a GPS antenna can be removed from antenna array 31, and AC/DC adapter 16 can be positioned and retained on lid 44 such that the overall dimensions of case 12 can be reduced. AC/DC adapter 16 can generally be located in position corresponding to the location of the GPS antenna on lid 44 shown in FIG. 1.

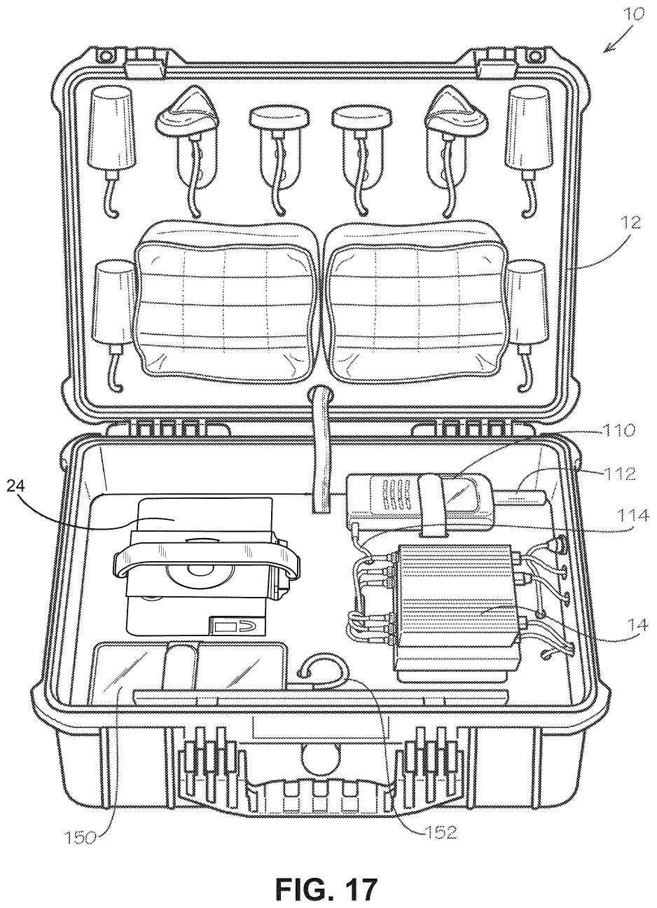

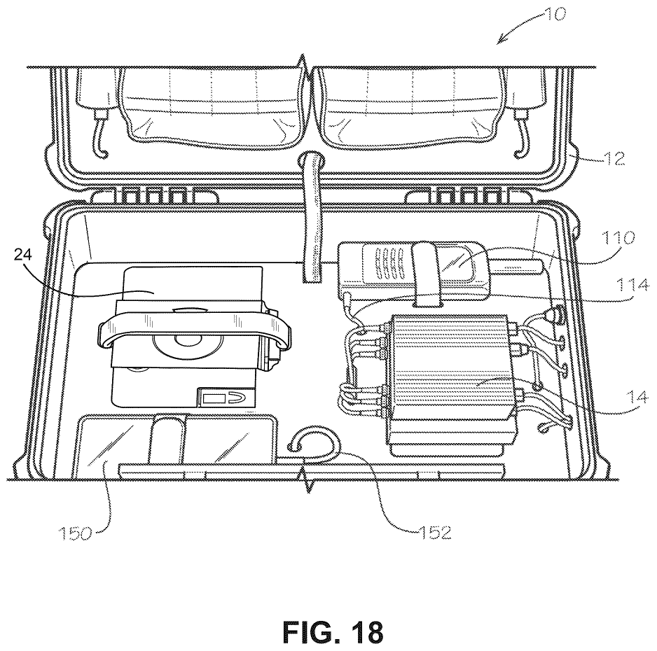

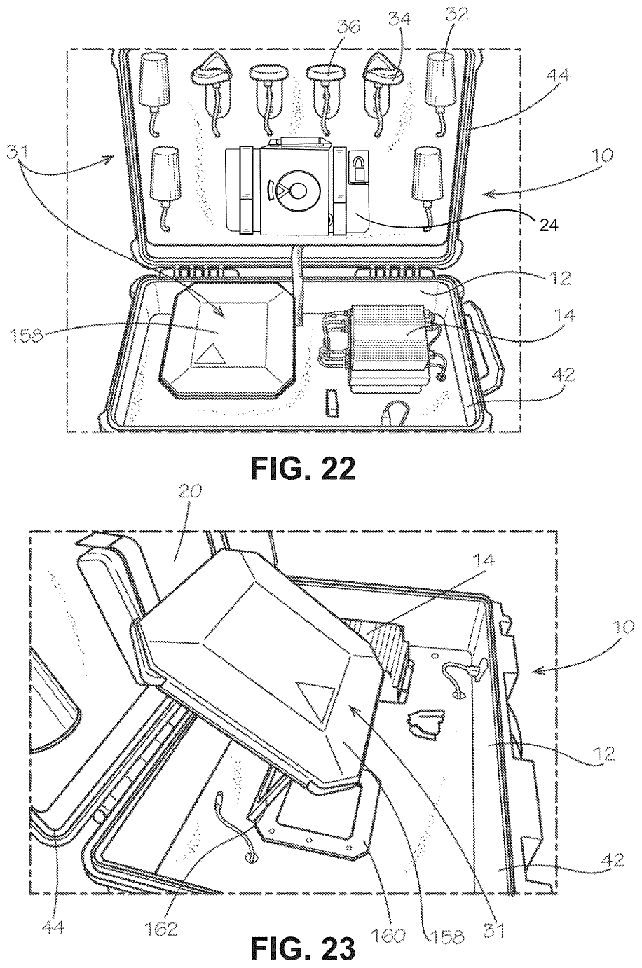

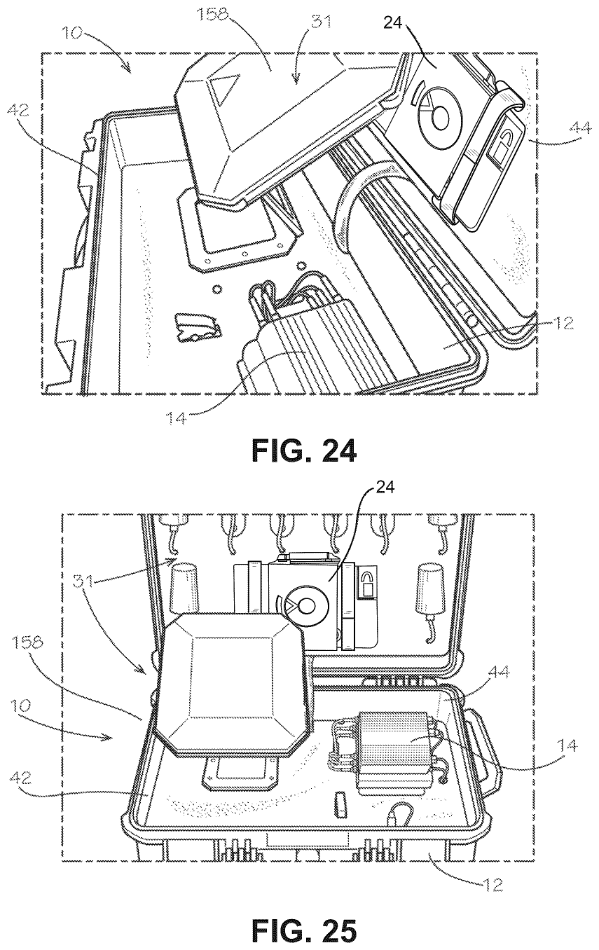

In some embodiments, as shown in FIGS. 17-25, the case 12 can be equipped with satellite communications components. In some embodiments, a satellite phone 110 can be connectable to the power supply 20 to selectively receive power from the power supply 20. The satellite phone 110 can be connected to the power supply 20 via satellite phone power cable 114. The satellite phone 110 can include its own satellite phone antenna 112 for communicating across a satellite network. In the event cellular and wireless service is disrupted, the satellite phone 110 can be used to communicate across a satellite network. In other embodiments, the satellite phone 110 can be wirelessly communicated with the router device 14.

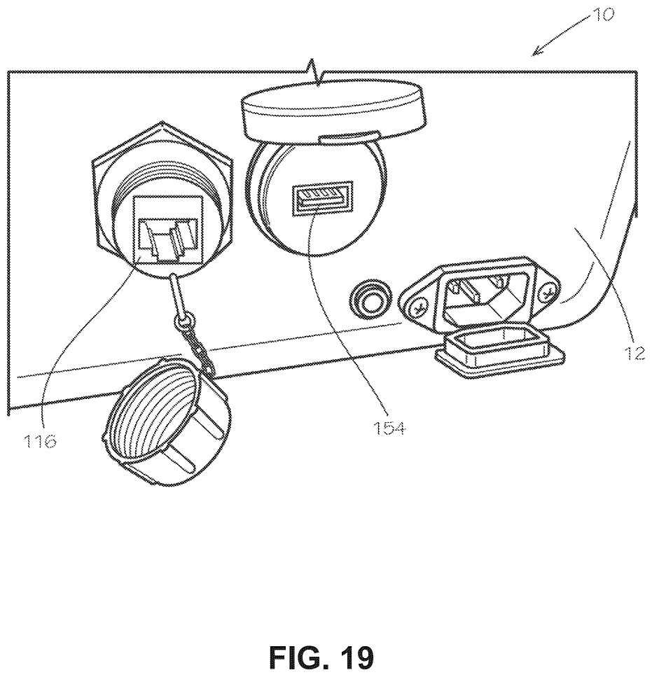

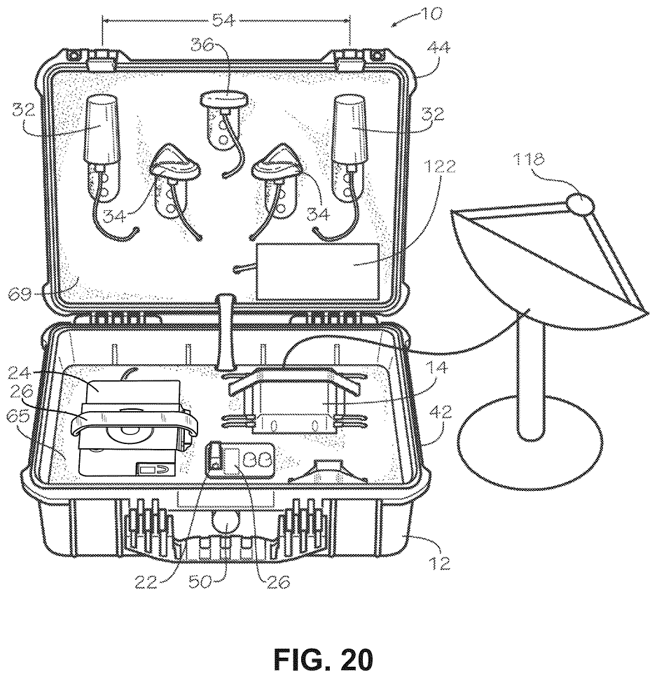

In the event that the case 12 is located indoors, in a vehicle, or otherwise in a location which restricts a direct line of communication between the satellite phone and a satellite in space, an external satellite antenna 118 can be used to communicate with the satellite as shown in FIG. 20. The external satellite antenna 118 can be electrically coupled to the router device 14 such that the satellite phone 110 or another user device can communicate over the satellite network via the router device 14 and external satellite antenna 118. In some embodiments, as shown in FIG. 19, the case 12 can include an Ethernet port 116 which can be electrically coupled to the router device 14 via an Ethernet cable connected between the Ethernet port 116 and a corresponding Ethernet port on the router device 14. The Ethernet port 116 can be used to connect external devices, such as an external satellite antenna 118, to the router device 14 to facilitate satellite communication. In some embodiments, the Ethernet port 16 can be an external port on the case 12, such that external satellite antennas, laptops, mobile devices, or other equipment can be coupled to the router device 14 directly through the Ethernet port 116 while the case 12 is otherwise in a closed orientation, thereby protecting the internal components positioned within the case 12. The case 12 can also include an external power port 154 which can be electrically coupled to the power supply 20. The external power port 154 can allow a device such as a laptop, mobile device, tablet, etc. to be selectively charged by the power supply 20. In some embodiments, the external power port 154 can be a USB port which can accommodate charging cables for varying devices.

In some embodiments, as shown in FIG. 28, the apparatus 10 can include an internal satellite antenna 122 secured within the case 12. The internal satellite antenna 122 can be mounted or otherwise secured to the lid 44 or the base 42 of the case 12 and electrically connected to the router device 14. The internal satellite antenna 122 can allow a user to communicate across a satellite network via the internal satellite antenna 122 and the router device 14.

The internal and/or external satellite antennas 122 and 118 respectively can be configured to communicate with any suitable satellite network or system, including but not limited to the Iridium or Iridium Certus™ systems, the lnmarsat® systems, or the STARLINK® systems. In some embodiments, the satellite antennas 122 and 118 can be configured to communicate via suitable satellite systems in the event suitable cellular communications cannot be established via the apparatus 10 and vice versa, such that the satellite communication may only be expended when necessary. For example, satellite communications may require more power than cellular communications. In some embodiments, the satellite antennas 122 and 118 can be configured to only allow text message communication via satellite to minimize the data transmitted via the satellite antennas 122 and 118 to further help minimize the power requirements of satellite communications. Such a text message restriction can allow emergency responders in extremely remote areas or in extremely wide area power outages to at least be able to get a text out to a desired party. Some satellite antennas compatible with these satellite systems can be quite large to achieve high bandwidth and transmission rates for satellite communications. In other embodiments, satellite communication may function the same as cellular communications, such that no limitations are imposed. Such antennas can thus require cases 12 with exterior dimensions having a largest dimension (length) of between about 30-40 inches to accommodate the larger satellite antenna.

In some circumstances, it may be desirable to transmit larger amounts of data via the apparatus 10 than can be accommodated efficiently by the generally smaller antenna on a satellite phone or an internal satellite antenna 122 that can be fixedly secured within the case 12, such as the transmission of large data files, video, etc. In some embodiments, the apparatus 10 can include an external satellite antenna 118 such as a satellite dish, which can be carried separately from the case 12. Larger satellite dishes 118 can allow for increased communication bandwidth with a satellite network in comparison to the built in satellite antennas on a satellite phone or smaller antennas. The external satellite antenna or dish 118 can be selectively electrically connected to the router device 14 such that a user can communicate across a satellite network via the external satellite antenna 112 and the router device 14. Such an external satellite antenna 118 can be connected to the external Ethernet port 116 shown in FIG. 19 in some embodiments. An external satellite antenna 118 can be collapsible in some embodiments such that between uses, a potentially larger external satellite antenna 118 or dish 118 can be conveniently stored in a satellite antenna carrying case to be carried along with the case 12. The external satellite antenna 118 can be expanded or constructed on site during use, connected to the router device 14, and positioned next to or near the case 12.

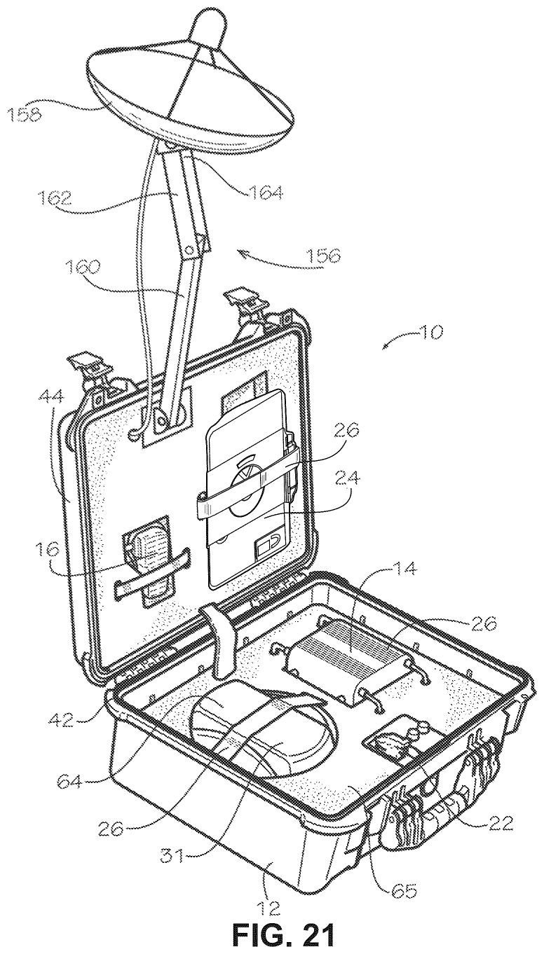

In still other embodiments, as shown in FIGS. 21-25, the apparatus 10 can include an integral satellite antenna or dish 158 that can be mounted to and stored within the case 12 of the apparatus 10. The integral satellite antenna or dish 158 can be fixed secured to either a base 42 or a lid 44 of the case 12. In other embodiments, the satellite antenna or dish 158 can be mounted to the case 12 via a satellite mounting assembly 156. The satellite mounting assembly 156 can generally transition the integral satellite antenna or dish 158 between an extended or transmission position and a retracted or storage position. In the extended position, the integral satellite antenna or dish 158 can be positioned above or outward from the case 12 such that the integral satellite antenna or dish 158 can have a clear path in a direction towards a satellite network in space without interference from the case 12. In the retracted position, the integral satellite antenna 158 can be retracted within or adjacent the lid 44 or the base 42 of the case 12 such that the integral satellite antenna 158 can be contained within the case 12 when the lid 44 is in a closed position on the base 42. The integral satellite antenna or dish 158 can be electrically connected to the router device 14 such that to use the satellite antenna or dish 158 the integral satellite antenna or dish 158 can simply be moved to an expanded or transmission position and the apparatus 10 can be turned on.

The satellite mounting assembly 156 in some embodiments can be two or more mounting arms or plates 160 and 162 pivotally connected to one another, a proximate mounting arm 160 pivotally connected to either the lid 44 or the base 42 of the case 12, with the integral satellite antenna or dish 158 connected to a distal end 164 of a distal mounting arm 162 of the mounting assembly 156. The mounting arms 160 and 162 can be folded into one another to position the integral satellite antenna or dish 158 adjacent the case 12 and in a position such that the integral satellite antenna or dish 158 can be enclosed within the case 12 when the lid 44 is in the closed position on the base 42. In some embodiments, the integral satellite antenna or dish 158 can itself be expandable or collapsible such that when the satellite mounting assembly 156 is in the retracted position, the integral antenna satellite or dish 158 can be collapsed to help minimize the storage space required within the case 12 to store the integral satellite antenna or dish 158. Specifically, in some embodiments, a bowl of the satellite antenna or dish 158 can be collapsed or folded into itself to minimize the size of the satellite antenna or dish 158 during storage. In some embodiments, the proximate arm or plate 160 of the satellite mounting assembly 156 can be fixedly connected to the case 12, and the distal arm or plate 162 can be pivotally connected to proximate arm or plate 160 and the satellite antenna 158. Having an adjustable satellite antenna on a pivoting mounting assembly 156 can allow a user to adjust the orientation of the satellite antenna 158 to achieve the strongest signal possible.

In still other embodiments, the satellite mounting assembly 156 can include telescoping arms which can be expanded or collapsed into one another to alternate the integral satellite antenna or dish 158 between the expanded position and the retracted position. A telescoping arm assembly of the satellite mounting assembly can be pivotally connected to the lid 44 or the base 42 of the case 12 to allow the position or orientation of the satellite antenna or dish 158 to be adjusted in the expanded position.

While FIGS. 1-28 show various components, including power supply 24, router device 14, antenna array 30, cellular antennas 32, wireless antennas 34, GPS antennas 36, power switch 22, adapter 16, etc., in various orientations and positions within case 12, base 42, and lid 44, each of the various components within case 12 can be positioned in either base 42 or lid 44 of case 12. In some embodiments, a portion of the antennas in antenna array 30 can be positioned within base 42, and a portion of the antennas in antenna array 30 can be positioned in lid 44. Among other reasons, it may be advantageous to position the antennas of the antenna array 30 in various positions within the case when using different size cases, due to varying numbers of different types of antennas used, or to shorten cable length between the antennas and the router device 14. It is contemplated that the size, shape, and configuration of the data communications case 12 and its various components discussed herein may widely vary.

Thus, although there have been described particular embodiments of the present invention of a new and useful POWER SYSTEM FOR DATA COMMUNICATIONS CASE, it is not intended that such references be construed as limitations upon the scope of this invention.

What is claimed is:

1. A data communications apparatus for providing a data communications network, the apparatus comprising:
a portable carrying case;
a router device positioned within the case, the router device including at least one cellular gateway configured for wide area network communication and at least one wireless network configured for local area network communication;
an antenna system operatively connected to the router device, the antenna system including at least one cellular antenna and a satellite communication antenna; and
a power system positioned within the case, the power system comprising:
a power bank configured to receive a plurality of batteries wired in parallel; and
an electrical board including a power boost circuit configured to provide increased output wattage to the satellite communication antenna;
wherein the electrical board is configured to power the satellite communication antenna without requiring a separate satellite-side router or power supply.

2. The apparatus of claim 1, wherein the power system further comprises a single cable extending between the power bank and the satellite communication antenna and configured to transmit both power and data.

3. The apparatus of claim 1, wherein the plurality of batteries are individually removable from the power bank.

4. The apparatus of claim 1, wherein the plurality of batteries comprises four batteries, each battery configured to deliver at least 99 Wh of power when fully charged.

5. The apparatus of claim 1, further comprising a base plate insertable within the case, and a bracket attached to the base plate, wherein the power bank is securable within the bracket.

6. The apparatus of claim 5, wherein the electrical board is coupled to the base plate on an opposite side relative to the power bank.

7. The apparatus of claim 1, wherein the batteries provide power to each of the at least one cellular antenna and the satellite communication antenna.

8. The apparatus of claim 1, wherein the power system includes a plurality of charging ports configured to receive power from at least one of an AC charger, vehicle charger, or solar panel.

9. A data communications apparatus comprising:
a portable carrying case;
a router device positioned within the case;
a satellite communication terminal stored within or mounted to the case and operatively connected to the router device; and
a power system including a plurality of batteries electrically coupled in parallel and configured to provide power to the router device and the satellite communication terminal.

10. The apparatus of claim 9, wherein the power system further comprises an electrical board including a power boost circuit configured to increase output wattage supplied to the satellite communication terminal.

11. The apparatus of claim 9, wherein the power system includes a microcontroller configured to monitor at least one of current draw, voltage, or power consumption of the satellite communication terminal.

12. The apparatus of claim 11, wherein the microcontroller is configured to automatically disconnect power to the satellite communication terminal when a power threshold is exceeded.

13. The apparatus of claim 9, wherein the power system further includes a temperature sensor configured to cause power to be disabled when a temperature threshold is exceeded.

14. The apparatus of claim 9, wherein the plurality of batteries are individually removable from a power bank positioned within the case.

15. A portable power platform comprising:
a carrying case;
a power bank positioned within the case and configured to receive a plurality of batteries such that the plurality of batteries are coupled in parallel;
an electrical board including a DC-to-DC power boost circuit; and
an output interface configured to provide power from the power bank to at least one external electronic device selected from the group consisting of a satellite antenna, wireless access point, camera, or networking device.

16. The portable power platform of claim 15, wherein the electrical board includes a power-over-Ethernet (PoE) power injector circuit.

17. The portable power platform of claim 15, wherein the output interface is configured to provide power through a single cable configured to transmit both power and data to a satellite antenna.

18. The portable power platform of claim 15, wherein the power bank includes four removable lithium-ion batteries each having a capacity of at least about 99 Wh.

19. The portable power platform of claim 15, wherein the electrical board includes a DC-to-DC boost circuit configured to power an external device without converting power from direct current to alternating current.

20. The portable power platform of claim 15, wherein the carrying case includes a plurality of charging ports configured to receive power from at least one of an AC charger, vehicle charger, or solar panel.
